(19) United States
(12) Patent Application Publication
(10) Pub. No.: US 2010/0274823 A1
(43) Pub. Date: Oct. 28, 2010

(54) METHOD, APPARATUS AND COMPUTER PROGRAM PRODUCT FOR PROVIDING AN ADAPTIVE CONTEXT MODEL FRAMEWORK

(76) Inventor: Sailesh Sathish, Tampere (FI)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 12/428,873

(22) Filed: Apr. 23, 2009

(51) Int. Cl. G06F 17/30

(52) U.S. Cl. 707/810; 707/E17.014

(57) ABSTRACT

An apparatus for providing adaptive context model framework may include a processor and a memory storing executable instructions that in response to execution by the processor cause the apparatus to perform various operations. The operations performed may include receiving data from a data provider for provision to an application, querying a generic data model for a representation associated with context data corresponding to the received data, translating the received data into an application specific model based on a response to the querying, and providing data to the application represented based on the application specific model. A corresponding method and computer program product are also provided.

### TECHNOLOGICAL FIELD

Embodiments of the present invention relate generally to communication interface technology and, more particularly, relate to a method, apparatus, and computer program product for providing an adaptive context model framework.

### BACKGROUND

The modern communications era has brought about a tremendous expansion of wireline and wireless networks. Computer networks, television networks, and telephony networks are experiencing an unprecedented technological expansion, fueled by consumer demand. Wireless and mobile networking technologies have addressed related consumer demands, while providing more flexibility and immediacy of information transfer.

Current and future networking technologies continue to facilitate ease of information transfer and convenience to users. One area in which there is a demand to increase ease of information transfer relates to the delivery of services to a user of a mobile terminal. The services may be in the form of a particular media or communication application desired by the user, such as a music player, a game player, an electronic book, short messages, email, content sharing, etc. The services may also be in the form of interactive applications in which the user may respond to a network device in order to perform a task or achieve a goal. The services may be provided from a network server or other network device, or even from the mobile terminal such as, for example, a mobile telephone, a mobile television, a mobile gaming system, etc.

In some situations, it may be desirable for an application (e.g., a web based application) to have the ability to access information or objects from a device providing information to the application. For example, context data including device data related to capabilities, current operating state and/or other device data that may be static and/or dynamic may be useful information for the application to access. In this regard, context data may be associated with content stored on a device in order to provide information which might assist in identifying data of interest. Context data is data that characterizes a particular situation at any point in time and may be either static or dynamic. Thus, for example, context data may represent device, system and environment data. The context data may be used by applications for different purposes, such as generating metadata or performing an adaptation based on the context. A context model is a mechanism by which organized or unorganized forms of context data can be exposed to a calling application. Meanwhile, a provider typically provides data to the context model. Usually, a context model exposes a fixed set of application programming interfaces (APIs) to applications that reflect the underlying nature of the context model itself.

There are several context models available to provide context data. The context models available may have different architectures and various applications may be developed for use with specific ones of the different architectures. The applications may be able to change their behavior (e.g., via dynamic adaptations) based on changing context data. In general, the context models may be considered to be either data based models or object based models. In data based models, data is available without consideration of who provided the data. Calling applications may query the system for a particular type of data to determine whether such data is available. However, in object based models, each provider of data has an object representation and the object can be queried in order to get current updated data. The APIs provide access to the object based model through which the current state of the object (e.g., the context data) can be queried. Object based model related systems are considered to be more organized and may be more likely to be deployed in mobile environments due to a lower cost of infrastructure, maintenance, manageability and efficiency.

Meanwhile, efforts are currently being made to develop a semantic web that, unlike the world wide web, which is tailored to describing documents and the links between them, enables the definition of semantics of information and services on the web. In this regard, for example, the semantic web may utilize embedded information (such as meta-information) about content within web pages to provide additional information regarding what a web page is about, the purpose of a particular tag, what certain content represents, and other information. The semantic information may be provided as additional tags or even as embedded information within existing tags. The semantic information may enable computers to perform more tasks utilizing information available via the web without human direction.

Currently, the amount of context data to which an application may be exposed is quite large. Examples of such context data may range from simple battery information to higher end abstractions such as a “predicted” movement of user. In some situations, it may not be desirable to expose all possible context data to applications as such a large amount of exposure may complicate application authoring and strain resources and efficiency of device middleware. In this regard, the more complicated and efficient a model becomes, the more memory and computing resource that are needed to support the model.

It is envisioned that applications may not share a single context model but may instead use a multitude of models that could be application specific and thereby become increasingly complex. Accordingly, it may be desirable to provide a more generic or adaptive context model framework.

### BRIEF SUMMARY

A method, apparatus and computer program product are therefore provided for an adaptive context model framework. In this regard, for example, an adaptive and customized context model framework for semantic web-based browser applications may be provided. Accordingly, for example, a browser model may be able to provide a customized model that is useful within the context of a particular web page. Thus, a browser model may employ an overall generic data model providing only those data sources that would be needed within the scope of a particular page.

In one exemplary embodiment, a method of providing an adaptive context model framework is provided. The method may include receiving data from a data provider for provision to an application, querying a generic data model for a representation associated with context data corresponding to the received data, translating the received data into an application specific model based on a response to the querying, and providing data to the application represented based on the application specific model.

In another exemplary embodiment, a computer program product for providing an adaptive context model framework is provided. The computer program product includes at least one computer-readable storage medium having computer-executable program code instructions stored therein. The computer-executable program code instructions may include program code instructions for receiving data from a data provider for provision to an application, querying a generic data model for a representation associated with context data corresponding to the received data, translating the received data into an application specific model based on a response to the querying, and providing data to the application represented based on the application specific model.

In another exemplary embodiment, an apparatus for providing an adaptive context model framework is provided. The apparatus may include a processor and a memory storing executable instructions that in response to execution by the processor cause the apparatus to perform various operations. The operations performed may include receiving data from a data provider for provision to an application, querying a generic data model for a representation associated with context data corresponding to the received data, translating the received data into an application specific model based on a response to the querying, and providing data to the application represented based on the application specific model.

Embodiments of the invention may provide a method, apparatus and computer program product for employment in a web based, or other network based operating environment. As a result, for example, device users may enjoy improved capabilities with respect to applications and services accessible via the device.

### BRIEF DESCRIPTION OF THE SEVERAL VIEWS OF THE DRAWING(S)

Having thus described embodiments of the invention in general terms, reference will now be made to the accompanying drawings, which are not necessarily drawn to scale, and wherein:

FIG. 1 is a schematic block diagram of a system showing an example of a communication environment according to an exemplary embodiment of the present invention;

FIG. 2 is a schematic block diagram of an apparatus for providing an adaptive context model framework according to an exemplary embodiment of the present invention;

FIG. 3 illustrates a block diagram of a framework within which the context model may be derived by the context model manager according to an exemplary embodiment of the present invention;

FIG. 4 illustrates a block diagram showing operation of a context model in relation to building a customized source-representation for web applications according to an exemplary embodiment of the present invention; and

FIG. 5 is a block diagram according to an exemplary method for providing an adaptive context model framework according to an exemplary embodiment of the present invention.

### DETAILED DESCRIPTION

Embodiments of the present invention will now be described more fully hereinafter with reference to the accompanying drawings, in which some, but not all embodiments of the invention are shown. Indeed, embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information” and similar terms may be used interchangeably to refer to data capable of being transmitted, received and/or stored in accordance with embodiments of the present invention. Moreover, the term “exemplary”, as used herein, is not provided to convey any qualitative assessment, but instead merely to convey an illustration of an example. Thus, use of any such terms should not be taken to limit the spirit and scope of embodiments of the present invention.

Electronic devices have been rapidly developing in relation to their communication capabilities. As the capabilities of such devices have increased, applications that are sensitive to the capabilities of the devices have also been developed. Thus, for example, applications that are sensitive to the current operating state or context of devices have been developed. The devices are often able to determine, keep and communicate information about their own current operating state. For example, battery level, available bandwidth, certain device settings, hardware and software capabilities, local ambient light level and many other state related pieces of information may be determined and/or communicated to other devices. In order to communicate information on device operating state to various applications such as, for example, an application associated with accessing the web, an interface may be provided that may employ a context model.

Context is generally defined as any information that can be used to characterize the situation of an entity. Context parameters may include parameters related to, for example, environmental context, social context, spatio-temporal context, task context, personal context, terminal context, service context, access context, and/or the like. As such, context data may be used to describe a set of characteristics of a device, a network, user preferences and other aspects that may apply to an interaction between the device and an application (e.g., a web application). Aspects of context data could be either static or dynamic. Static aspects may include color resolution, display size, keyboard arrangement or other fixed properties of the device. Dynamic aspects may include properties of the device that may change over time such as current battery level, device orientation, device location, other applications running, and numerous other like characteristics.

As indicated above, the next generation web (e.g., the semantic web) aims to utilize device and user context data in order to perform customized and adaptive services to the user. Semantics may provide additional descriptions about web page particulars that may be provided to an application to enable such customized and adaptive services to be provided. In some embodiments, RDF (Resource Description Framework) may be the mechanism by which such descriptions are provided. A popular way of describing semantics in the current web is through the use of microformats. Microformats are short RDF based descriptions that have become popular due to having a strong user base and have nearly become de-facto standards themselves.

Current web access to models typically depends on direct API calls to a static set of properties, which is neither a scalable solution nor a portable solution across devices. Moreover, current web access to models is typically short term and not usable in dynamic environments such as smart spaces. Accordingly, embodiments of the present invention may combine the power of semantic web descriptions for particular web pages with a framework for a context model providing customized models that make sense within the context of the particular web pages.

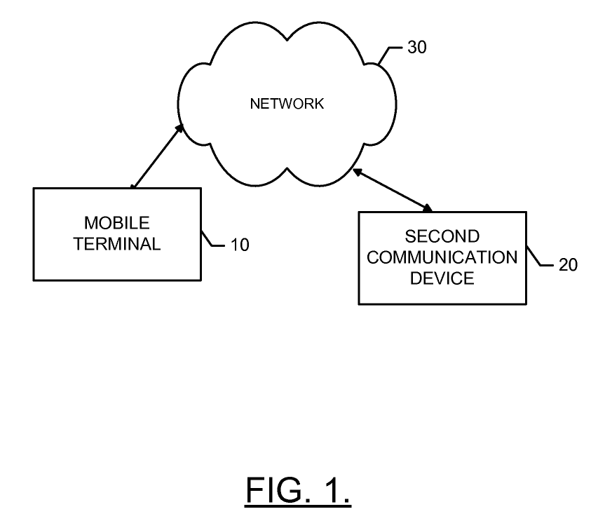

FIG. 1 illustrates a generic system diagram in which a device such as a mobile terminal 10 is shown in an exemplary communication environment. As shown in FIG. 1, an embodiment of a system in accordance with an example embodiment of the present invention may include a first communication device (e.g., mobile terminal 10) capable of communication with other devices via a network 30. In some cases, embodiments of the present invention may further include one or more additional communication devices, one of which is depicted in FIG. 1 as a second communication device 20. In some embodiments, not all systems that employ embodiments of the present invention may comprise all the devices illustrated and/or described herein. In an exemplary embodiment, the mobile terminal 10 and/or the second communication device 20 may be examples of terminals, such as portable digital assistants (PDAs), pagers, mobile televisions, mobile telephones, gaming devices, laptop computers, cameras, video recorders, audio/video players, radios, global positioning system (GPS) devices, or any combination of the aforementioned, and other types of voice and text communications devices. However, other devices may also employ embodiments of the present invention. Furthermore, devices that are not mobile, such as servers and personal computers may also readily employ embodiments of the present invention.

The network 30 may include a collection of various different nodes, devices or functions that may be in communication with each other via corresponding wired and/or wireless interfaces. As such, the illustration of FIG. 1 should be understood to be an example of a broad view of certain elements of the system and not an all inclusive or detailed view of the system or the network 30. Although not necessary, in some embodiments, the network 30 may be capable of supporting communication in accordance with any one or more of a number of First-Generation (1G), Second-Generation (2G), 2.5G, Third-Generation (3G), 3.5G, 3.9G, Fourth-Generation (4G) mobile communication protocols, Long Term Evolution (LTE), and/or the like. In some embodiments, the network 30 may be a P2P (peer-to-peer) network.

One or more communication terminals such as the mobile terminal 10 and the second communication device 20 may be in communication with each other via the network 30 and each may include an antenna or antennas for transmitting signals to and for receiving signals from a base site, which could be, for example a base station that is a part of one or more cellular or mobile networks or an access point that may be coupled to a data network, such as a Local Area Network (LAN), a Metropolitan Area Network (MAN), and/or a Wide Area Network (WAN), such as the Internet. In turn, other devices such as processing elements (e.g., personal computers, server computers or the like) may be coupled to the mobile terminal 10 and/or the second communication device 20 via the network 30. By directly or indirectly connecting the mobile terminal 10 and the second communication device 20 (and/or other devices) to the network 30, the mobile terminal 10 and the second communication device 20 may be enabled to communicate with the other devices or each other, for example, according to numerous communication protocols including Hypertext Transfer Protocol (HTTP) and/or the like, to thereby carry out various communication or other functions of the mobile terminal 10 and the second communication device 20, respectively.

Furthermore, although not shown in FIG. 1, the mobile terminal 10 and the second communication device 20 may communicate in accordance with, for example, radio frequency (RF), Bluetooth (BT), Infrared (IR) or any of a number of different wireline or wireless communication techniques, including LAN, Wireless LAN (WLAN), Worldwide Interoperability for Microwave Access (WiMAX), WiFi, Ultra-Wide Band (UWB), Wibree techniques and/or the like. As such, the mobile terminal 10 and the second communication device 20 may be enabled to communicate with the network 30 and each other by any of numerous different access mechanisms. For example, mobile access mechanisms such as Wideband Code Division Multiple Access (W-CDMA), CDMA2000, Global System for Mobile communications (GSM), General Packet Radio Service (GPRS) and/or the like may be supported as well as wireless access mechanisms such as WLAN, WiMAX, and/or the like and fixed access mechanisms such as Digital Subscriber Line (DSL), cable modems, Ethernet and/or the like.

In an exemplary embodiment, the network 30 may be an ad hoc or distributed network arranged to be a smart space. Thus, devices may enter and/or leave the network 30 and the devices of the network 30 may be capable of adjusting operations based on the entrance and/or exit of other devices to account for the addition or subtraction of respective devices or nodes and their corresponding capabilities. In an exemplary embodiment, one or more of the devices in communication with the network 30 may employ a context model to assist in providing an interface between applications and data providers. As such, for example, a consumer application may request information from a data provider within the network 30 and any one of the mobile terminal 10 or the second communication device 20 may host the consumer application while any other one of the mobile terminal 10 or the second communication device 20 (or some other network device) acts as a provider with respect to the consumer application to provide information such as semantic and/or context information to the respective consumer application. The context model may therefore define a representation for various ones of objects, documents, web pages or other data represented in the model.

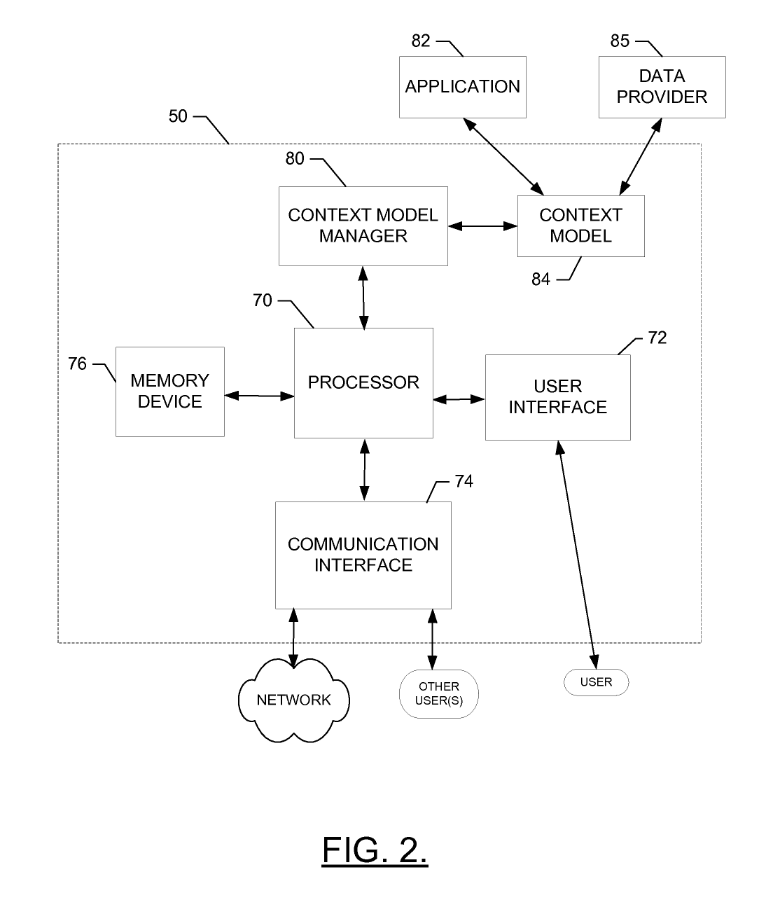

FIG. 2 illustrates a schematic block diagram of an apparatus for enabling the provision of an adaptive context model framework according to an exemplary embodiment of the present invention. An exemplary embodiment of the invention will now be described with reference to FIG. 2, in which certain elements of an apparatus 50 for providing an adaptive context model framework are displayed. The apparatus 50 of FIG. 2 may be employed, for example, on the mobile terminal 10 (and/or the second communication device 20). Alternatively, the apparatus 50 may be embodied on a network device of the network 30. However, the apparatus 50 may alternatively be embodied at a variety of other devices, both mobile and fixed (such as, for example, any of the devices listed above). In some cases, embodiments may be employed on a combination of devices. Accordingly, some embodiments of the present invention may be embodied wholly at a single device (e.g., the mobile terminal 10), by a plurality of devices in a distributed fashion (e.g., on one or a plurality of devices in a P2P network) or by devices in a client/server relationship. Furthermore, it should be noted that the devices or elements described below may not be mandatory and thus some may be omitted in certain embodiments.

Referring now to FIG. 2, an apparatus 50 for providing an adaptive context model framework is provided. The apparatus 50 may include or otherwise be in communication with a processor 70, a user interface 72, a communication interface 74 and a memory device 76. The memory device 76 may include, for example, volatile and/or non-volatile memory. The memory device 76 may be configured to store information, data, applications, instructions or the like for enabling the apparatus to carry out various functions in accordance with exemplary embodiments of the present invention. For example, the memory device 76 could be configured to buffer input data for processing by the processor 70. Additionally or alternatively, the memory device 76 could be configured to store instructions for execution by the processor 70. As yet another alternative, the memory device 76 may be one of a plurality of databases that store information and/or media content.

The processor 70 may be embodied in a number of different ways. For example, the processor 70 may be embodied as various processing means such as a processing element, a coprocessor, a controller or various other processing devices including integrated circuits such as, for example, an ASIC (application specific integrated circuit), an FPGA (field programmable gate array), a hardware accelerator, or the like. In an exemplary embodiment, the processor 70 may be configured to execute instructions stored in the memory device 76 or otherwise accessible to the processor 70. As such, whether configured by hardware or software methods, or by a combination thereof, the processor 70 may represent an entity (e.g., physically embodied in circuitry) capable of performing operations according to embodiments of the present invention while configured accordingly. Thus, for example, when the processor 70 is embodied as an ASIC, FPGA or the like, the processor 70 may be specifically configured hardware for conducting the operations described herein. Alternatively, as another example, when the processor 70 is embodied as an executor of software instructions, the instructions may specifically configure the processor 70, which may in some cases otherwise be a general purpose processing element or other functionally configurable circuitry if not for the specific configuration provided by the instructions, to perform the algorithms and/or operations described herein. However, in some cases, the processor 70 may be a processor of a specific device (e.g., a mobile terminal or server) adapted for employing embodiments of the present invention by further configuration of the processor 70 by instructions for performing the algorithms and/or operations described herein.

Meanwhile, the communication interface 74 may be any means such as a device or circuitry embodied in either hardware, software, or a combination of hardware and software that is configured to receive and/or transmit data from/to a network and/or any other device or module in communication with the apparatus 50. In this regard, the communication interface 74 may include, for example, an antenna (or multiple antennas) and supporting hardware and/or software for enabling communications with a wireless communication network (e.g., network 30). In fixed environments, the communication interface 74 may alternatively or also support wired communication. As such, the communication interface 74 may include a communication modem and/or other hardware/software for supporting communication via cable, digital subscriber line (DSL), universal serial bus (USB), Ethernet or other mechanisms.

The user interface 72 may be in communication with the processor 70 to receive an indication of a user input at the user interface 72 and/or to provide an audible, visual, mechanical or other output to the user. As such, the user interface 72 may include, for example, a keyboard, a mouse, a joystick, a display, a touch screen, a microphone, a speaker, or other input/output mechanisms. In an exemplary embodiment in which the apparatus is embodied as a server or some other network devices, the user interface 72 may be limited, remotely located, or eliminated.

In an exemplary embodiment, the processor 70 may be embodied as, include or otherwise control a context model manager 80. The context model manager 80 may be any means such as a device or circuitry operating in accordance with software or otherwise embodied in hardware or a combination of hardware and software (e.g., processor 70 operating under software control, the processor 70 embodied as an ASIC or FPGA specifically configured to perform the operations described herein, or a combination thereof) thereby configuring the device or circuitry to perform the corresponding functions of the context model manager 80 as described below. Thus, in examples in which software is employed, a device or circuitry (e.g., the processor 70 in one example) executing the software forms the structure associated with such means. In this regard, for example, the context model manager 80 may be configured to provide, among other things, for the translation of generic data representative of data provided from data providers into a context model 84 that may include application specific context models for use by applications. More specifically, the context model manager 80 may enable generation of the context model 84, such that the context model 84 may include an application specific model for one or more applications. The application specific model(s) may be built based on information gathered from information provided within the application and sourcing data provided by a certain set of data providers. Thus, for example, the context model manager 80 may be configured to receive data from a data provider for provision to an application, query a generic data model for specific sets of context data, translate the received data into an application specific model (e.g., as a portion of the context model 84) based on a response to the query, and provide data to the application through an application specific model.

In some embodiments, the context model manager 80 may be in communication with one or more applications (e.g., application 82) that may act as consumers with respect to device context information provided. Application 82 may be a web application or some other network application for which information about properties associated with the apparatus 50 of FIG. 2 may be useful. As such, in some cases, the application 82 may be in communication with the context model manager 80 via the communication interface 74 (and/or via the processor 70).

In an exemplary embodiment, the context model 84 may serve as a communication interface between data providers (e.g., data provider 85) and the application 82. The data provider 85 could be either a local provider or a remote provider, which may act as a source of data. The data provider 82, like the application 82, may be in direct communication with the context model manager 80 (and/or the context model 84), or may establish such communication via the communication interface 74 or the processor 70.

In an exemplary embodiment, the context model manager 80 may be embodied in software as instructions that are stored in the memory of a communication device (e.g., the mobile terminal 10 and/or the second communication device 20) and executed by the processor 70. Alternatively, the context model manager 80 may be embodied as software that forms a part of or is installed on middleware, for example, of the communication device. As another alternative, the context model manager 80 may be embodied as the processor 70 (e.g., as an FPGA, ASIC, or the like). The context model manager 80 may be configured to develop and/or implement usage of a context model (e.g., context model 84) including a model representation of multiple (in some cases all) devices in communication with the communication device (e.g., the mobile terminal 10 and/or the second communication device 20).

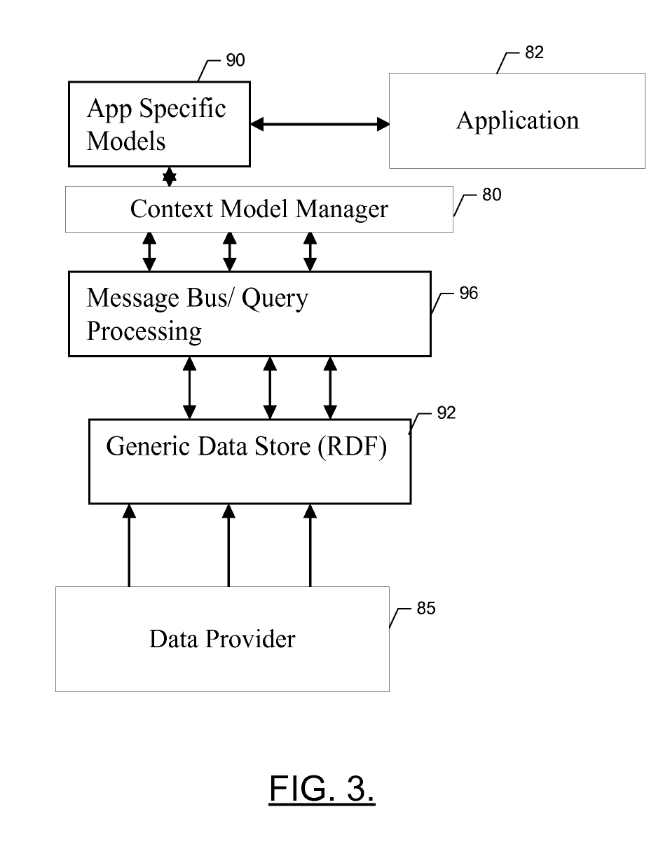

FIG. 3 illustrates a block diagram of a framework within which the context model 84 may be derived by the context model manager 80 according to an exemplary embodiment. As shown in FIG. 3, there may be applications (e.g., application 82) running within a device such as the mobile terminal 10. All such applications may have the potential to utilize context data in order to perform adaptive services with respect to the user. Furthermore, one or more of the applications may have its own data model(s) (e.g., application specific models 90) and representations with application specific API's fine tuned for such representations. Accordingly, the context model manager 80 may be configured to conform the context model 84 to the corresponding representations. Therefore, the context model manager 80 may be configured to provide a translation, as needed so that the middleware of the mobile terminal 10 supports a base data model via which data can be described in its base form (as far as possible) so that any application specific model can derive its own representations from the corresponding base model.

RDF is a triple based format that is based on subject, object and predicate information. The subject and object are linked through the predicate. Using such triples, it may be possible to formulate or describe any data down to a lower form. In an exemplary embodiment, the context model 84 may employ an RDF based representation where any context providers can “put” their data in along with additional metadata and descriptions.

In this regard, the data providers (e.g., data provider 85) put RDF based data into a generic data store 92 that may include the generic data representations (e.g., in a generic data model). The context model manager 80 may include one or more application model translators 94 configured to query the generic data store 92 (or communicate with the generic data store through notifications) via a message bus 96 for data. The application model translators 94 may be any means such as a device or circuitry operating in accordance with software or otherwise embodied in hardware or a combination of hardware and software thereby configuring the device or circuitry to perform the corresponding functions of the application model translators 94 as described herein. The data may then be translated to the application specific model 90 by the application model translators 94 of the context model manager 80 and thereby be represented appropriately for the application 84. Accordingly, multiple applications can be simultaneously serviced by a single generic data model while also ensuring that each type of application gets its own corresponding model.

According to an exemplary embodiment, one or more browser specific models may be produced corresponding to a respective browser application (e.g., browser application 98. In this regard, in the context of a browser specific model, the model may be made to be customized to a specific web page. Such customization may prevent the model from uploading irrelevant context data, which may thereby save on memory requirements or otherwise speed up searches and queries for the application, while reducing processing speed. However, embodiments of the present invention are independent of any specific browser context model such as Delivery Context Client Interface (DCCI) or other representations. As such, embodiments of the present invention are generic enough to enable application to an object-based or data-based model even though for browsers, object-based representations for context may sometimes be preferred.

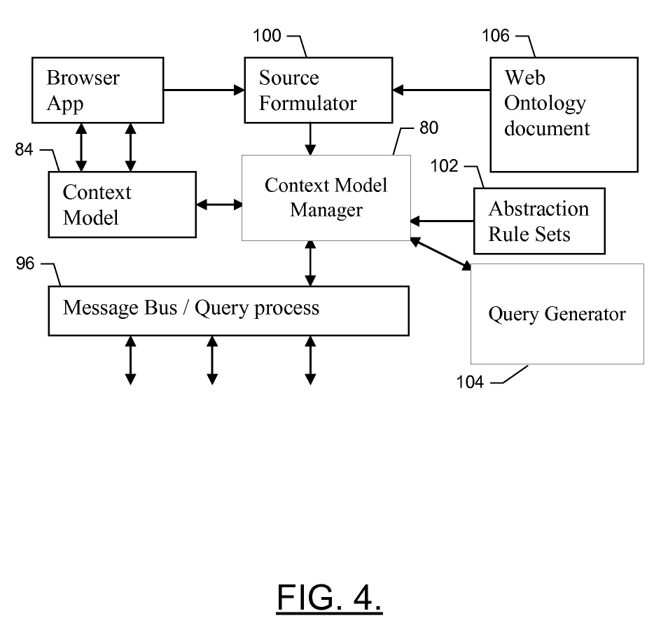

FIG. 4 illustrates a block diagram showing operation of a context model in relation to building a customized source-representation for web applications according to an exemplary embodiment of the present invention. When a browser loads a web page, a context plug-in (or extension to the browser) may read in the semantic content (e.g., in RDF or other formats) and make an informed decision on the context sources to be employed in connection with the current web page either by referring to a web ontology or by directly reading in required sources from information provided via the web page itself. In relation to direct sources, as an example, the web page author may be enabled to embed direct sources of semantic content as attribute values within a “contextSources” tag. For example, the web application author can mention that a particular page only needs GPS, battery and network signal strength information.

Referring now to FIG. 4, the context model manager 80 may be in communication with, include or otherwise have access to or control over various other entities, some of which are shown in FIG. 4. In this regard, the context model manager 80 may be in communication with a source formulator 100, an abstraction rule set 102 and a query generator 104. The source formulator 100 and the query generator 104 may each be any means such as a device or circuitry operating in accordance with software or otherwise embodied in hardware or a combination of hardware and software (e.g., processor 70 operating under software control, the processor 70 embodied as an ASIC or FPGA specifically configured to perform the operations described herein, or a combination thereof) thereby configuring the device or circuitry to perform the corresponding functions of the source formulator 100 and the query generator 104, respectively, as described herein.

After receiving data regarding a particular web page via the message bus 96, the context model manager 80 may be configured to parse the semantic web description of the particular web page for descriptions thereof. The descriptions may then be communicated to the source formulator 100, which may be configured to compare the descriptions to web ontology document 106 (for example, the World Wide Web Consortium (W3C) Delivery Context Ontology). By referring to the ontology, the formulator 100 may be enabled to find a top most parent property node description that best matches the current description (e.g., a highest level of description). In an exemplary embodiment, the ontology is usable to identify a set of properties that the current application would need that has to be provided through the context model. In some cases, this will yield multiple higher level object descriptions that may be passed on to the context model manager 80, which may function as a context source build manager. As the source build manager, the context model manager 80 may be configured to compare the object descriptions with any rule sets that identify mechanisms for building abstractions from raw RDF data (e.g., from the abstraction rule set 102). A list may then be formulated for each abstraction. The list may include a listing of RDF triples that are to be retrieved from the generic data model. The list of triples to be retrieved may then be communicated to the query generator 104 (e.g., a SPARQL (SPARQL Protocol and RDF Query Language) query generator), which may be configured to build a query string for sending onto the message bus 96 to retrieve the triples in the list of triples to be retrieved. Additional queries related to monitoring events and changes to the list of triples to be retrieved may be added by the context model manager 80 and transmitted as appropriate.

A query is sent via the message bus 96 and, once the triples are obtained (e.g., from an RDF base model associated with the generic data store 92), the received triples may be passed to the context model manager 80 to enable the context model manager 80 to build abstractions based on the abstraction rule sets 102. After the build is complete, the web ontology document 106 may be referenced again to determine an actual place for each object within the context model 84. The specific steps utilized to accomplish the above described process may vary depending on the model. It should be noted that an initial RDF model is assumed and it may generally be easier to formulate queries from RDF descriptions within web pages than those of the generic model. Other models could also or alternatively be employed other than RDF representations for the base model.

A potential advantage of the above described framework is that the models only have to host those properties that are actually needed by the browser application 98. Each object representation may require proper management including monitoring changes to the data triples, building representations and maintaining events and handlers. Management such as this may require relatively large amounts of memory and processing power. Therefore, reducing the number of data objects as provided in embodiments of the present invention by only hosting those properties actually needed by a particular application may improve efficiency. For the next generation of web applications and frameworks (e.g., the semantic web), having such functionality may be beneficial both from the middleware and hardware support perspective, as well as from the perspective of the application author.

Accordingly, some exemplary embodiments of the present invention provide for potential savings of memory requirements and processing time and may simplify queries for application authors. In this regard, some embodiments provide for a reduction in the amount of objects that need to be handled by virtue of the provision of application specific models. Thus, requirements associated with maintaining updates and event handlers for a particular model, may be decreased. In this regard, for example, by utilizing microformats or some other generic information (e.g., RDF based descriptions) provided by a consumer application, objects likely to be needed or otherwise employed in connection with that particular (e.g., current) application may be determined. Thus, for example, an exemplary embodiment of the present invention is configured to receive data from a data provider for provision to a generic context model, query a generic data model for context data, translate the received (queried) data into an application specific model based on information gathered from the application (through embedded RDF or Microformats), and provide data to the application represented based on the application specific model.

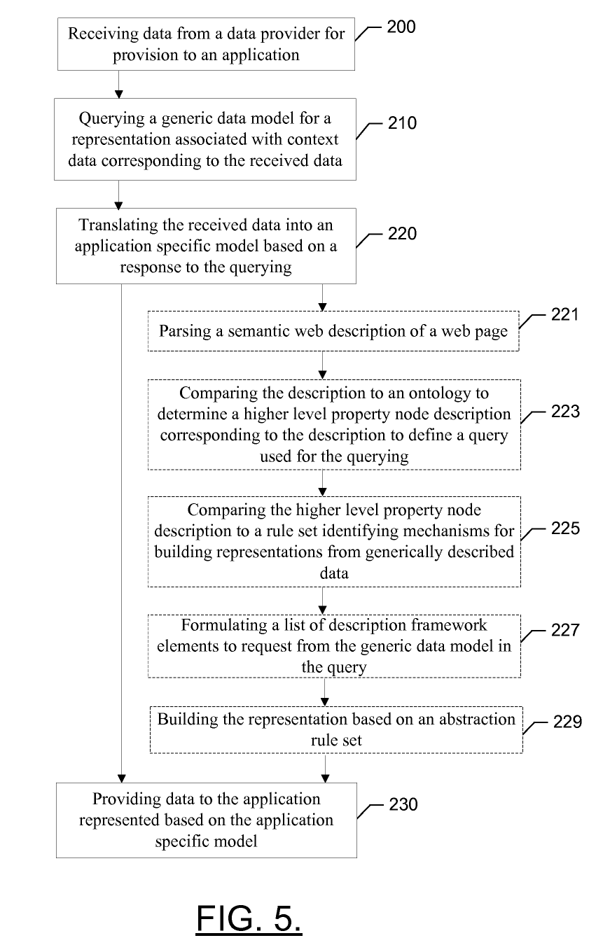

FIG. 5 is a flowchart of a system, method and program product according to exemplary embodiments of the invention. It will be understood that each block or step of the flowchart, and combinations of blocks in the flowchart, may be implemented by various means, such as hardware, firmware, processor, circuitry and/or other device associated with execution of software including one or more computer program instructions. For example, one or more of the procedures described above may be embodied by computer program instructions. In this regard, the computer program instructions which embody the procedures described above may be stored by a memory device of the mobile terminal or network device and executed by a processor in the mobile terminal or network device. As will be appreciated, any such computer program instructions may be loaded onto a computer or other programmable apparatus (e.g., hardware) to produce a machine, such that the resulting computer or other programmable apparatus embody means for implementing the functions specified in the flowchart block(s) or step(s). These computer program instructions may also be stored in a computer-readable memory that may direct a computer or other programmable apparatus to function in a particular manner, such that the instructions stored in the computer-readable memory produce an article of manufacture the execution of which implements the function specified in the flowchart block(s) or step(s). The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the flowchart block(s) or step(s).

Accordingly, blocks or steps of the flowchart support combinations of means for performing the specified functions, combinations of steps for performing the specified functions and program instruction means for performing the specified functions. It will also be understood that one or more blocks or steps of the flowchart, and combinations of blocks or steps in the flowchart, can be implemented by special purpose hardware-based computer systems which perform the specified functions or steps, or combinations of special purpose hardware and computer instructions.

In this regard, one embodiment of a method for providing an adaptive context model framework as illustrated, for example, in FIG. 5 includes receiving data from a data provider for provision to an application at operation 200 and querying a generic data model for a representation associated with context data corresponding to the received data at operation 210. The method may further include translating the received data into an application specific model based on a response to the querying at operation 220 and providing data to the application represented based on the application specific model at operation 230.

In some embodiments, the operations above certain ones of the operations above may be modified or further amplified as described below and, in accordance with some examples, shown in dashed lines in FIG. 5. Optional operations or modifications may be performed in any order and/or in combination with each other in various alternative embodiments. As such, in some cases, translating the received data may include parsing a semantic web description of a web page at operation 221, comparing the description to an ontology to determine a higher level property node description corresponding to the description to define a query used for the querying at operation 223, and comparing the higher level property node description to a rule set identifying mechanisms for building representations from generically described data at operation 225. In some examples, translating the received data may further include formulating a list of description framework elements to request from the generic data model in the query at operation 227 and building the representation based on an abstraction rule set. In an exemplary embodiment, the method may further include, after completion of the building of the representation, referencing the ontology to determine a location of objects within the application specific model.

In an exemplary embodiment, an apparatus for performing the method of FIG. 5 above may comprise a processor (e.g., the processor 70) configured to perform some or each of the operations (200-230) described above. The processor may, for example, be configured to perform the operations (200-230) by performing hardware implemented logical functions, executing stored instructions, or executing algorithms for performing each of the operations. Alternatively, the apparatus may comprise means for performing each of the operations described above. In this regard, according to an example embodiment, examples of means for performing operations 200-230 may comprise, for example, the processor 70, the context model manager 80, and/or a device or circuit for executing instructions or executing an algorithm for processing information as described above.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method comprising:
receiving data from a data provider for provision to an application;
querying a generic data model for a representation associated with context data corresponding to the received data;
translating, via a processor, the received data into an application specific model based on a response to the querying; and
providing data to the application represented based on the application specific model.

2. The method of claim 1, wherein querying the generic data model comprises querying a model including Resource Description Framework based data.

3. The method of claim 1, wherein translating the received data comprises:
parsing a semantic web description of a web page;
comparing the description to an ontology to determine a higher level property node description corresponding to the description to define a query used for the querying; and
comparing the higher level property node description to a rule set identifying mechanisms for building representations from generically described data.

4. The method of claim 3, wherein translating the received data further includes translating based on data received from the application.

5. The method of claim 3, wherein translating the received data further comprises formulating a list of description framework elements to request from the generic data model in the query.

6. The method of claim 5, wherein translating the received data further comprises building the representation based on an abstraction rule set.

7. The method of claim 6, further comprising, after completion of the building of the representation, referencing the ontology to determine a location of objects within the application specific model.

8. A computer program product comprising at least one computer-readable storage medium having computer-executable program code instructions stored therein, the computer-executable program code instruction comprising:
program code instructions for receiving data from a data provider for provision to an application;
program code instructions for querying a generic data model for a representation associated with context data corresponding to the received data;
program code instructions for translating the received data into an application specific model based on a response to the querying; and
program code instructions for providing data to the application represented based on the application specific model.

9. The computer program product of claim 8, wherein program code instructions for querying the generic data model include instructions for querying a model including Resource Description Framework based data.

10. The computer program product of claim 8, wherein program code instructions for translating the received data include instructions for:
parsing a semantic web description of a web page;
comparing the description to an ontology to determine a higher level property node description corresponding to the description to define a query used for the querying; and
comparing the higher level property node description to a rule set identifying mechanisms for building representations from generically described data.

11. The computer program product of claim 10, wherein program code instructions for translating the received data further include instructions for translating based on data received from the application.

12. The computer program product of claim 10, wherein program code instructions for translating the received data further include instructions for formulating a list of description framework elements to request from the generic data model in the query.

13. The computer program product of claim 12, wherein program code instructions for translating the received data further include instructions for building the representation based on an abstraction rule set.

14. An apparatus comprising a processor and a memory storing executable instructions that in response to execution by the processor cause the apparatus to at least perform the following:
receiving data from a data provider for provision to an application;
querying a generic data model for a representation associated with context data corresponding to the received data;
translating the received data into an application specific model based on a response to the querying; and
providing data to the application represented based on the application specific model.

15. The apparatus of claim 14, wherein the instructions further cause the apparatus to query a model including Resource Description Framework based data.

16. The apparatus of claim 14, wherein the instructions further cause the apparatus to translate the received data by:
parsing a semantic web description of a web page;
comparing the description to an ontology to determine a higher level property node description corresponding to the description to define a query used for the querying; and
comparing the higher level property node description to a rule set identifying mechanisms for building representations from generically described data.

17. The apparatus of claim 16, wherein the instructions further cause the apparatus to translate the received data including translating based on data received from the application.

18. The apparatus of claim 16, wherein the instructions further cause the apparatus to translate the received data by formulating a list of description framework elements to request from the generic data model in the query.

19. The apparatus of claim 18, wherein the instructions further cause the apparatus to translate the received data by building the representation based on an abstraction rule set.

20. The apparatus of claim 19, wherein the instructions further cause the apparatus to, after completion of the building of the representation, reference the ontology to determine a location of objects within the application specific model.
